(19) United States
(12) Patent Application Publication
(10) Pub. No.: US 2009/0268037 A1
(43) Pub. Date: Oct. 29, 2009

(54) Video Calibration System Capable of Performing Automatic Calibration and Related Method

(76) Inventors: Li-Yu Yang, Taipei Hsien (TW); Ping-Hung Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/411,381

(22) Filed: Mar. 25, 2009

(30) Foreign Application Priority Data
Apr. 29, 2008 (TW) 097115696

(51) Int. Cl. H04N 17/02

(52) U.S. Cl. 348/189; 348/E17.004

(57) ABSTRACT

A video calibration system capable of performing automatic calibration is utilized for testing a display device, and includes a pattern generator for generating testing signals corresponding to the display device, an oscilloscope coupled to the pattern generator, for displaying waveforms of the testing signals provided by the pattern generator, and an operating device coupled to the pattern generator and the oscilloscope, including a calibration software for automatically adjusting configuration of the pattern generator according to signals of the oscilloscope, so as to control the pattern generator to generate the testing signals in conformation with a predefined specification.

### BACKGROUND OF THE INVENTION

1. Field of the Invention

The present invention relates to a video calibration system capable of performing automatic calibration and related method, and more particularly, to a video calibration system and related method capable of saving time, enhancing efficiency, and enhancing calibration precision.

2. Description of the Prior Art

A display device undergoes tests in all aspects before into markets, to judge if different video signals can be displayed correctly. Generally, a test procedure is via a pattern generator (or signal generator) to generate video signals in conformation with a predefined specification to the display device, to test display abilities of the display device. Therefore, correction of the video signals generated by the pattern generator can affect testing results.

Please refer to FIG. 1. FIG. 1 is a schematic diagram of a video calibration system 10 in the prior art. In the video calibration system 10, a pattern generator 100 is utilized for generating video signals to a display device 102. To make sure that the pattern generator 100 can output correct video signals, before testing the display device 102, calibration and adjustment of the pattern generator 100 must be performed. However, in the prior art, adjustment of the pattern generator 100 depends on observation of an oscilloscope 104 showing waveforms generated by the pattern generator 100, and repeated fine-tuning of the waveforms according to signal deviation in a specific region, causing waste of time and energy, and degradation of efficiency. Therefore, the industries work for developing technology for automatically calibrating the pattern generator.

### SUMMARY OF THE INVENTION

It is therefore a primary objective of the claimed invention to provide a video calibration system capable of performing automatic calibration and related method.

The present invention discloses a video calibration system capable of performing automatic calibration and the video calibration system is utilized for testing a display device. The video calibration system comprises a pattern generator, an oscilloscope and an operating device. The pattern generator is utilized for generating testing signals corresponding to the display device. The oscilloscope is coupled to the pattern generator, for displaying waveforms of the testing signals provided by the pattern generator. The operating device is coupled to the pattern generator and the oscilloscope, comprising a calibration software for automatically adjusting configuration of the pattern generator according to signals of the oscilloscope, so as to control the pattern generator to generate the testing signals in conformation with a predefined specification.

The present invention further discloses a method for automatically calibrating a video calibration system and the method is utilized for testing a display device. The method comprises generating testing signals corresponding to the display device by a pattern generator of the video calibration system, displaying waveforms of the testing signals provided by the pattern generator by an oscilloscope of the video calibration system, and adjusting configuration of the pattern generator automatically according to signals of the oscilloscope, so as to control the pattern generator to generate the testing signals in conformation with a predefined specification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a video calibration system in the prior art.

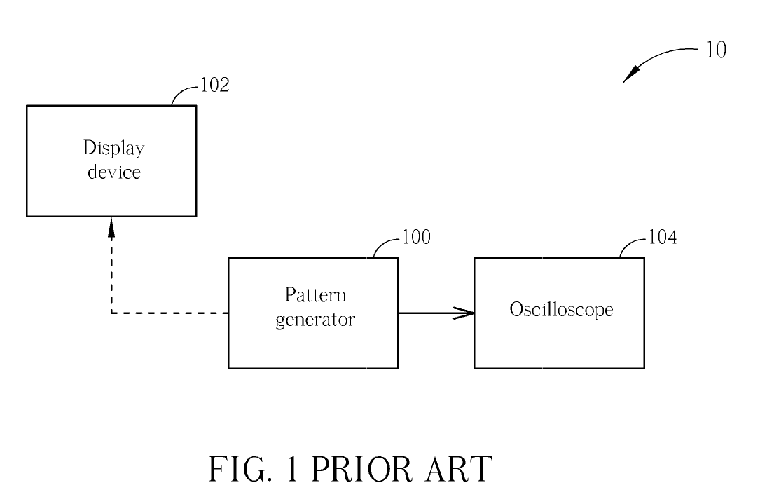

FIG. 2 is a schematic diagram of a video calibration system capable of performing automatic calibration according to an embodiment of the present invention.

FIG. 3 is a schematic diagram of an automatic calibration procedure according to an embodiment of the present invention.

### DETAILED DESCRIPTION

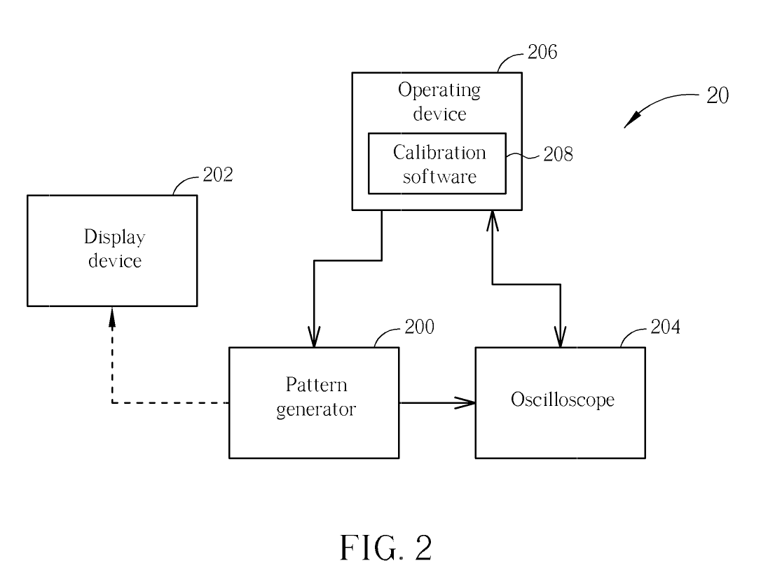

Please refer to FIG. 2. FIG. 2 is a schematic diagram of a video calibration system 20 capable of performing automatic calibration according to an embodiment of the present invention. The video calibration system 20 is utilized for testing a display device 202, and comprises a pattern generator 200, an oscilloscope 204 and an operating device 206. The pattern generator 200 is utilized for generating testing signals corresponding to the display device 202. The oscilloscope 204 is coupled to the pattern generator 200, and utilized for displaying waveforms of the testing signals provided by the pattern generator 200. The operating device 206 is preferably a computer system, and comprises a calibration software 208 for automatically adjusting configuration of the pattern generator 200 according to signals of the oscilloscope 204, so as to control the pattern generator 200 to generate the testing signals in conformation with a predefined specification.

To make sure that the pattern generator 200 can output correct video signals, before testing the display device 202, calibration and adjustment of the pattern generator 200 must be performed. The present invention automatically adjusts configuration of the pattern generator 200 by the calibration software 208, without repeated and tedious adjustment.

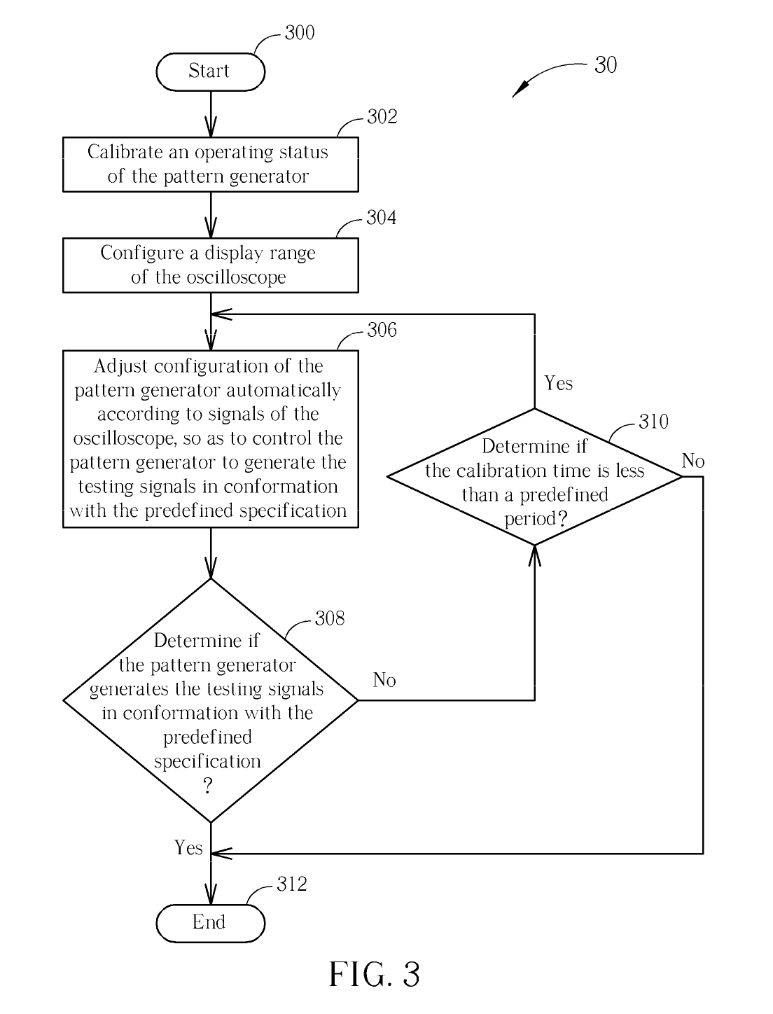

As for the calibration method of the calibration software 208, please refer to FIG. 3. FIG. 3 is a schematic diagram of an automatic calibration procedure 30 according to an embodiment of the present invention. The automatic calibration procedure 30 comprises the following steps:

Step 300: Start. When starting calibrating, the pattern generator 200 generates testing signals corresponding to the display device 202 and the oscilloscope 204 displays waveforms of the testing signals provided by the pattern generator 200.

Step 302: Calibrate an operating status of the pattern generator 200.

Step 304: Configure a display range of the oscilloscope 204.

Step 306: Adjust configuration of the pattern generator 200 automatically according to signals of the oscilloscope 204, so as to control the pattern generator 200 to generate the testing signals in conformation with the predefined specification.

Step 308: Determine if the pattern generator 200 generates the testing signals in conformation with the predefined specification. If so, then go to Step 312; if not, go to Step 310.

Step 310: Determine if the calibration time is less than a predefined period. If so, then go back to Step 306; if not, go to Step 312.

Step 312: End.

According to the automatic calibration procedure 30, when starting calibration, the calibration software 208 calibrates the operating status of the pattern generator 200, so as to make sure that the pattern generator 200 can work normally. Meanwhile, the calibration software 208 configures the display range of the oscilloscope 204 to display waveforms of the testing signals correctly. Then, the calibration software 208 automatically adjusts configuration of the pattern generator 200 according to signals of the oscilloscope 204, so as to control the pattern generator 200 to generate the testing signals in conformation with the predefined specification. If the testing signals generated by the pattern generator 200 do not conform to the predefined specification, the present invention checks if the calibration time is less than the predefined period. If the calibration time is less than the predefined period, then continue to calibrate. If the calibration time is more than or equal to the predefined period, then stop calibrating to avoid spending too long calibration time, and preferably output an indication information, for indicating that the calibration software 208 cannot adjust the pattern generator 200 to generate the testing signals in conformation with the predefined specification. On the contrast, if the pattern generator 200 generates the testing signals in conformation with the predefined specification, then stop calibrating.

Therefore, according to the automatic calibration procedure 30, the calibration software 208 can automatically adjust configuration of the pattern generator 200 without manual adjustment repeatedly and tediously, and stop calibrating when the pattern generator 200 cannot generate the testing signals in conformation with the predefined specification.

Please note that, FIG. 2 and FIG. 3 are exemplary embodiments of the present invention, and those skilled in the art can make alternations and modifications accordingly. For example, when automatically adjusting configuration of the pattern generator 200, the calibration software 208 can automatically select an instruction from an instruction set according to signals of the oscilloscope 204, so as to automatically adjust configuration of the pattern generator 200.

In the prior art, calibration of the pattern generator is performed via manual operation to observe waveforms received from the pattern generator in the oscilloscope, and fine-tuning to meet the predefined specification. Thus, the manual operation not only wastes time and energy but causes errors as well. In comparison, the present invention communicates with a standard interface of the oscilloscope via a computer, to automatically capture precise waveforms and calibrate accordingly, so as to enhance precision of the calibration.

In conclusion, the present invention can automatically calibrate the pattern generator without manual adjustment repeatedly and tediously, to save time, enhance efficiency and calibration precision, and make sure that the pattern generator outputs correct video signals.

Those skilled in the art will readily observe that numerous modifications and alterations of the device and method may be made while retaining the teachings of the invention.

What is claimed is:

1. A video calibration system capable of performing automatic calibration, utilized for testing a display device, comprising:
a pattern generator for generating testing signals corresponding to the display device;
an oscilloscope coupled to the pattern generator, for displaying waveforms of the testing signals provided by the pattern generator; and
an operating device coupled to the pattern generator and the oscilloscope, comprising a calibration software for automatically adjusting configuration of the pattern generator according to signals of the oscilloscope, so as to control the pattern generator to generate the testing signals in conformation with a predefined specification.

2. The video calibration system of claim 1, wherein the operating device is a computer system.

3. The video calibration system of claim 1, wherein when starting to test the display device, the calibration software is further utilized for calibrating an operating status of the pattern generator.

4. The video calibration system of claim 1, wherein when starting to test the display device, the calibration software is further utilized for configuring a display range of the oscilloscope.

5. The video calibration system of claim 1, wherein the calibration software is further utilized for determining if the pattern generator generates the testing signals in conformation with the predefined specification.

6. The video calibration system of claim 5, wherein the calibration software is further utilized for stopping adjusting configuration of the pattern generator when unable to adjust the pattern generator to generate the testing signals in conformation with the predefined specification in a predefined period.

7. The video calibration system of claim 6, wherein the calibration software is further utilized for outputting an indication information, for indicating that the calibration software cannot adjust the pattern generator to generate the testing signals in conformation with the predefined specification.

8. The video calibration system of claim 1, wherein the calibration software automatically selects an instruction from an instruction set according to signals of the oscilloscope, so as to automatically adjust configuration of the pattern generator.

9. A method for automatically calibrating a video calibration system, utilized for testing a display device, comprising:
generating testing signals corresponding to the display device by a pattern generator of the video calibration system;
displaying waveforms of the testing signals provided by the pattern generator by an oscilloscope of the video calibration system; and
adjusting configuration of the pattern generator automatically according to signals of the oscilloscope, so as to control the pattern generator to generate the testing signals in conformation with a predefined specification.

10. The method of claim 9 further comprising calibrating an operating status of the pattern generator when starting to test the display device.

11. The method of claim 9 further comprising configuring a display range of the oscilloscope when starting to test the display device.

12. The method of claim 9 further comprising determining if the pattern generator generates the testing signals in conformation with the predefined specification.

13. The method of claim 12 further comprising stopping adjusting configuration of the pattern generator when unable to adjust the pattern generator to generate the testing signals in conformation with the predefined specification in a predefined period.

14. The method of claim 13 further comprising outputting an indication information, for indicating that the pattern generator cannot be adjusted to generate the testing signals in conformation with the predefined specification.

15. The method of claim 9, wherein adjusting configuration of the pattern generator automatically according to signals of the oscilloscope is selecting an instruction from an instruction set automatically according to signals of the oscilloscope, so as to automatically adjust configuration of the pattern generator.
